(19) United States
(12) Patent Application Publication
(10) Pub. No.: US 2020/0296259 A1
(43) Pub. Date: Sep. 17, 2020

(54) METHOD AND APPARATUS FOR DETERMINING DEPTH VALUE

(71) Applicant: SZ DJI TECHNOLOGY CO., LTD., Shenzhen (CN)

(72) Inventors: Zhenbo LU, Shenzhen (CN); Zisheng CAO, Shenzhen (CN); Pan HU, Shenzhen (CN)

(21) Appl. No.: 16/887,942

(22) Filed: May 29, 2020

Related U.S. Application Data
(63) Continuation of application No. PCT/CN2017/114020, filed on Nov. 30, 2017.

(51) Int. Cl. H04N 5/222; G06T 5/00; G06T 5/10; G06T 7/571

(52) U.S. Cl. CPC H04N 5/2226; G06T 7/571; G06T 5/10; G06T 5/003

(57) ABSTRACT

The present disclosure provides a method for determining a depth value. The method includes adjusting a distance between an image sensor and a lens included in an image acquisition device M times by moving the image sensor, where M is an integer greater than 1; acquiring an image for each N of M times after adjusting the distance between the image sensor and the lens, where N is an integer less than or equal to M; calculating depth values of pixel points in the N acquired images; and determining a target depth value of the pixel point at a position in each of the images based on the depth value of the pixel point in each image.

### CROSS-REFERENCE TO RELATED APPLICATION

This application is a continuation of International Application No. PCT/CN2017/114020, filed on Nov. 30, 2017, the entire content of which is incorporated herein by reference.

### TECHNICAL FIELD

The present disclosure relates to the field of image technology and, more specifically, to a method and apparatus for determining a depth value, a machine-readable storage medium, and a mobile device.

### BACKGROUND

When a camera is taking an image, its lens focal length and the distance from the image sensor plane to the lens (i.e., the imaging distance) are fixed. Based on the convex lens imaging principle, the distance from the object to the lens can be obtained, that is, the object distance dₒ, the lens focal length f, and the imaging distance dᵢ may satisfy the following relationship:

$$\frac{1}{{d}_{o}} + \frac{1}{{d}_{i}} = \frac{1}{f} ,$$

that is,

$${d}_{o} = \frac{f {d}_{i}}{{d}_{i} - f} .$$

When the distance between the point in the scene and the lens is not equal to the focusing distance, that is, the object distance do, the point will form a diffuse spot point on the imaging plane. When the opening angle of the diffuse spot relative to the human eye is less than the angular resolution limit of the human eye, the human eye will not feel that the corresponding point is unclear, and the diffuse spot at this time is called the circle of confusion limit. When the opening angle of the diffuse spot relative to the human eye is greater than or equal to the limiting angular resolution of the human eye, the human eye can perceive the scene being blurry.

### SUMMARY

One aspect of the present disclosure provides a method for determining a depth value. The method includes adjusting a distance between an image sensor and a lens included in an image acquisition device M times by moving the image sensor, where M is an integer greater than 1; acquiring an image for each N of M times after adjusting the distance between the image sensor and the lens, where N is an integer less than or equal to M; calculating depth values of pixel points in the N acquired images; and determining a target depth value of the pixel point at a position in each of the images based on the depth value of the pixel point in each image.

Another aspect of the present disclosure provides an apparatus for determining a depth value. The apparatus includes a processor configured to: adjust a distance between an image sensor and a lens included in an image acquisition device M times by moving the image sensor, where M is an integer greater than 1; acquire an image for each N of M times after adjusting the distance between the image sensor and the lens, where N is an integer less than or equal to M; calculate depth values of pixel points in the N acquired images; and determine a target depth value of the pixel point at a position in the image based on the depth value of the pixel point in each image.

Another aspect of the present disclosure provides a mobile device. The mobile device includes a lens; an image sensor; and one or more processors working separately or in conjunction and configured to: adjust a distance between the image sensor and the lens M times by moving the image sensor, where M is an integer greater than 1; acquire an image for each N of M times after adjusting the distance between the image sensor and the lens, where N is an integer less than or equal to M; calculate depth values of pixel points in the N acquired images; and determine a target depth value of the pixel point at a position in the image based on the depth value of the pixel point in each image.

By using the embodiments of the present disclosure, on one hand, the depth value of each position in a scene corresponding to the acquired image may be determined without human intervention, which may improve the degree of automation and facilitate the adjustment of parameters such as the depth of field based on the depth value in the subsequent process. On the other hand, there may be no need to move and change the imaging position during the imaging process, which may not only reduce the complexity of the operation, but also ensure that parameters such as attitude of the image acquisition device are fixed, thereby ensuring the depth value may be accurately determined. Further, since the structure of the sensor in the image acquisition device is generally not complicated, the sensor may be easy to move, which makes the technical solution corresponding to the present embodiment easy to implement.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a diagram of an extreme foreground depth of field in the conventional technology.

FIG. 2 is a diagram of an extreme background depth of field in the conventional technology.

FIG. 3 is a flowchart of a method for determining a depth value according to an embodiment of the present disclosure.

FIG. 4 is a flowchart of calculating the depth value according to an embodiment of the present disclosure.

FIG. 5 is a flowchart of calculating a diffuse spot radius according to an embodiment of the present disclosure.

FIG. 6 is diagram of the depth value according to an embodiment of the present disclosure.

FIG. 7 is a diagram of another depth value according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure. Unless a conflict exists, the embodiments and features of the embodiments can be combined.

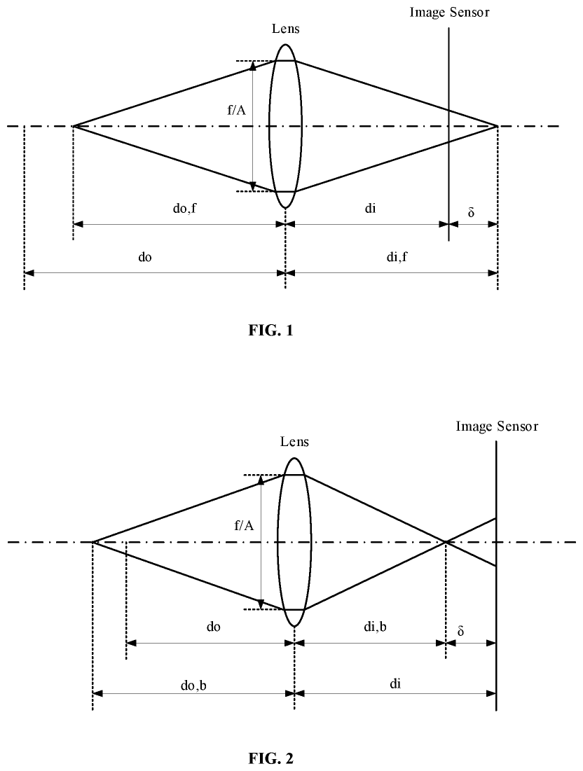

As shown in FIG. 1, set the radius of the circle of confusion limit to R1, the extreme foreground depth of field for which the size of the diffuse spot will not be perceived by the human eye may be d_{o,f,} which satisfies the relationship of

$${d}_{o , f} = \frac{{f}^{2} {d}_{o}}{2 {d}_{o} {R}_{l} A - 2 {fR}_{l} A + {f}^{2}} .$$

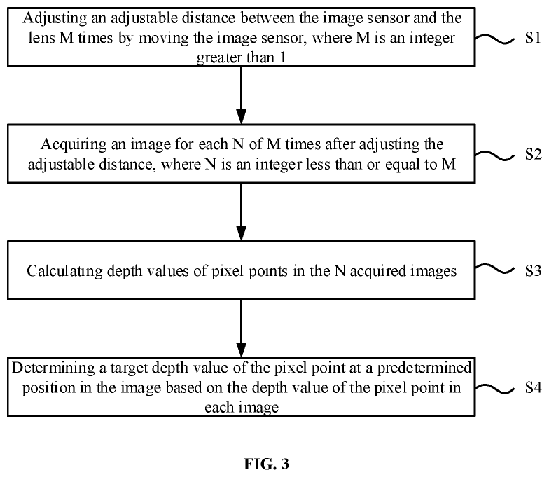

Further, as shown in FIG. 2, the extreme background depth of field for which the size of the diffuse spot will not be perceived by the human eye may be d_{o,b,} which satisfies the relationship of

$${d}_{o , b} = \frac{{f}^{2} {d}_{o}}{- 2 {d}_{o} {R}_{l} A + 2 {fR}_{l} A + {f}^{2}} ,$$

where A may be the aperture value of the camera, δ may be the defocus distance, and d_{i,f} and d_{i,b} may be the imaging distances.

In order to capture images with different depth effects for a scene, the following implementation methods mainly used in the conventional technology.

In the first implementation method, a photographer may manually adjust the focus, aperture, and object distance to change the depth of field of the object being photographed, such that the same scene can be taken with different blurring effects. By using this method, the depth of the scene cannot be extracted, and there may be errors in the manual focus.

In the second implementation method, the same scene may be photographed from different directions using one camera. Subsequently, the known camera internal parameters may be combined with technologies such as feature matching to calibrate the camera attitude information corresponding to each photo. Further, the perspective differences of a plurality of photos may be used to reconstruct the scene in three dimensions to obtain the depth map of the scene. Lastly, the captured image can be adjusted based on the depth map. By using this method, since the relative attitude change of the camera in different direction is uncertain, there is often a large deviation in the estimation of the camera attitude, which may directly affect the subsequent depth calculation, and ultimately affect the accuracy of the image adjustment.

FIG. 3 is a flowchart of a method for determining a depth value according to an embodiment of the present disclosure. The method for determining the depth value described in the embodiments of the present disclosure may be applied to an image acquisition device, such as a camera, an unmanned aerial vehicle (UAV), a mobile phone, etc. The image acquisition device may include a lens and an image sensor. The method for determining the depth value is described in detail below.

S1, adjusting an adjustable distance between the image sensor and the lens M times by moving the image sensor, where M may be an integer greater than 1.

In some embodiments, the movement of the image sensor may be controlled by a motor, such as a piezoelectric motor. In addition, a control signal may be transmitted to the piezoelectric motor by using a system on chip (SOC), such that the piezoelectric motor may drive the image sensor to move.

In some embodiments, the process of moving the image sensor may be the process of changing the imaging distance from the maximum imaging distance to the minimum imaging distance, or the process of changing the imaging distance from the minimum imaging distance to the maximum imaging distance.

In some embodiments, the adjustable distance of the image sensor may be the same or different each time. Further adjustable distance of the image sensor may be set as needed.

S2, acquiring an image for each N of M times after adjusting the adjustable distance, where N may be an integer less than or equal to M.

In some embodiments, the shutter of the image acquisition device may be controlled by the SOC. During the movement of the image sensor, the SOC may control the shutter to be in a closed state. In the N times, after each movement process is completed, the SCO may control the shutter to open, such that an exposure shooting may be performed and an image at the current object distance may be acquired.

In some embodiments, N may be an integer less than M. That is, in the process of moving the image sensor M times, the image may not be acquired after each time the image sensor is moved. Instead, the image may be acquired after every N times the movement process of the image sensor is completed.

In some embodiments, N may be an integer equal to M. That is, in the process of moving the image sensor M times, an image may be acquired after each time the image sensor is moved.

The following embodiments will be described by taking M equals to N as an example.

S3, calculating depth values of pixel points in the N acquired images.

S4, determining a target depth value of the pixel point at a predetermined position in the image based on the depth value of the pixel point in each image.

In some embodiments, for each of the N images, the depth value of each pixel point in the image may be calculated. Further, for the pixel point of each position in the image, an average value of the depth values of the pixel point at a position in the N images may be calculated respectively as the target depth value of the pixel point at the position.

In some embodiments, for each of the N images, the depth value of each pixel point in the image may be calculated. Subsequently, for the pixel points for which the depth values are calculated, the average value of the depth values of the pixel point at a position in the N images may be calculated respectively as the target depth value of the pixel point at the position.

In some embodiments, a diffuse spot radius of the pixel point at the predetermined position in the image may be calculated first, then, based on the relationship between the depth value and the diffuse spot radius, a calculation formula corresponding to the relationship may be selected to calculate the depth value. A specific example of calculating the depth value will be described in the following embodiments.

By using the embodiments of the present disclosure, on one hand, the depth value of each position in a scene corresponding to the acquired image may be determined without human intervention, which may improve the degree of automation and facilitate the adjustment of parameters such as the depth of field based on the depth value in the subsequent process. On the other hand, there may be no need to move and change the imaging position during the imaging process, which may not only reduce the complexity of the operation, but also ensure that parameters such as attitude of the image acquisition device are fixed, thereby ensuring the depth value may be accurately determined. Further, since the structure of the sensor in the image acquisition device is generally not complicated, the sensor may be easy to move, which makes the technical solution corresponding to the present embodiment easy to implement.

In some embodiments, adjusting the adjustable distance between the image sensor and the lens M times may include adjusting the adjustable distance M times based on the same and/or different step values.

In some embodiments, the adjustable distance of the image sensor may be the same or different each time. Further adjustable distance of the image sensor may be set as needed.

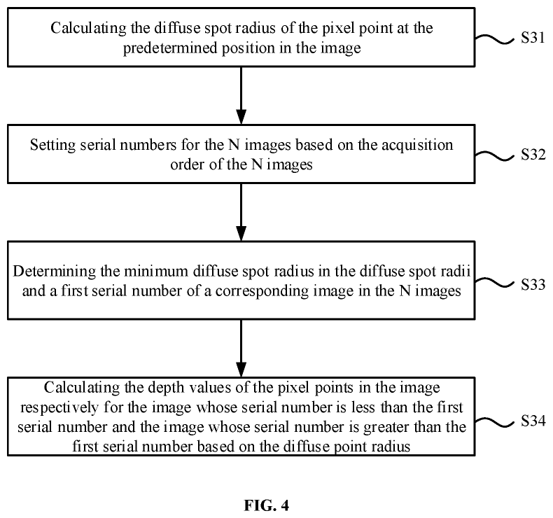

FIG. 4 is a flowchart of calculating the depth value according to an embodiment of the present disclosure. As shown in FIG. 4, based on the embodiment shown in FIG. 3, the calculation of the depth values of the pixel points in the N images acquired will be described in detail below.

S31, calculating the diffuse spot radius of the pixel point at the predetermined position in the image.

S32, setting serial numbers for the N images based on the acquisition order of the N images.

S33, determining the minimum diffuse spot radius in the diffuse spot radii and a first serial number of a corresponding image in the N images.

S34, calculating the depth values of the pixel points in the image respectively for the image whose serial number may be less than the first serial number and the image whose serial number may be greater than the first serial number based on the diffuse point radius.

In some embodiments, since the N images are acquired during the process of moving the image sensor, and for the images acquired before the image with the minimum diffuse spot radius and images acquired after the image with the minimum diffuse spot radius are reached, the relationship between the depth values of the pixel points in the images and the diffuse spot radius may be different. Therefore, serial numbers may be set for the N images in the order of acquisition, and the relationship between the serial number of each image and the first serial number of the image corresponding to the minimum diffuse spot radius to determine he images acquired before the image with the minimum diffuse spot radius and images acquired after the image with the minimum diffuse spot radius, thereby ensuring that the relationship between the diffuse spot radius and the depth value may be accurately determined.

It should be noted that, in addition to setting the serial number based on the acquisition order, setting the serial number based on the acquisition order may also include setting the serial number in the reverse order of the acquisition order.

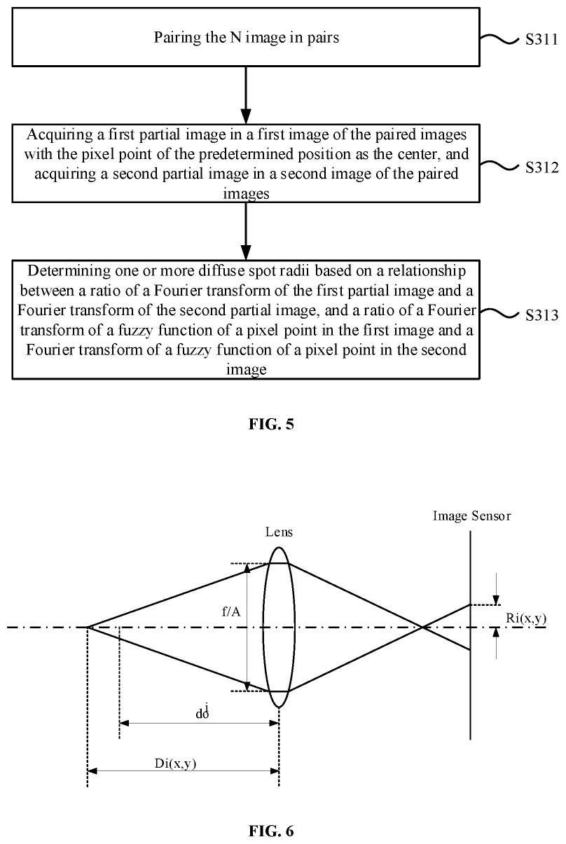

FIG. 5 is a flowchart of calculating a diffuse spot radius according to an embodiment of the present disclosure. As shown in FIG. 5, based on the embodiment shown in FIG. 4, the calculation of the diffuse spot radius of a pixel point at the predetermined position in the image will be described in detail below.

S311, pairing the N image in pairs.

In some embodiments, the N images may be paired in pairs to acquire 0.5N(N−1) image pairs (Iᵢ, Iⱼ), where Iᵢ and Iⱼ may respectively be any image in the N images, I and j may be integers, and I may be less than or equal to N, where j may be less than or equal to N.

S312, acquiring a first partial image in a first image of the paired images with the pixel point of the predetermined position as the center, and acquiring a second partial image in a second image of the paired images.

In some embodiments, a partial image with a length of W pixel points may be acquired in Ii and a partial image of a length of W pixel points may be acquired in Iⱼ by using the pixel point at the predetermined position as the center.

S313, determining one or more diffuse spot radii based on a relationship between a ratio of a Fourier transform of the first partial image and a Fourier transform of the second partial image, and a ratio of a Fourier transform of a fuzzy function of a pixel point in the first image and a Fourier transform of a fuzzy function of a pixel point in the second image.

In some embodiments, the formula (1) may be calculated first. In particular, Equation (1) may be ln

$$\frac{F ( {I}_{i}^{W} )}{F ( {I}_{j}^{W} )} = ln \frac{F ( {S}^{W} ) F ( {h}_{i} ( x , y ) )}{F ( {S}^{W} ) F ( {h}_{j} ( x , y ) )} = ln \frac{F ( {h}_{i} ( x , y ) )}{F ( {h}_{j} ( x , y ) )} ,$$

where F( ) may be a Fourier transform, S^{W} may be an accurately focused image of the original image corresponding to the image, hᵢ(x, y) may be a fuzzy function of the pixel point in Iᵢ, and hⱼ(x, y) may be a fuzzy function of the pixel point in Iⱼ.

Based on Equation (1) and the Gaussian model relationship between the fuzzy function and the diffuse spot radius, Equation (2) may be ln

$$\frac{F ( {I}_{i}^{W} ) ( u , v )}{F ( {I}_{j}^{W} ) ( u , v )} = \sqrt{2 π} ( {R}_{j}^{2} ( x , y ) - {R}_{i}^{2} ( x , y ) ) ( {u}^{2} + {v}^{2} ) ,$$

where Rᵢ(x, y) may be the diffuse spot radius of the pixel point in Iᵢ, Rⱼ(x,y) may be the diffuse spot radius of the pixel point in Iⱼ, and (u, v) may be the coordinate of the pixel point (x, y) in the frequency domain.

Further, by solving Equation (2), at least one Rᵢ(x,y) may be determined.

In some embodiments, determining the at least one diffuse spot radius may include assigning values to the coordinates of the pixel points in relation with of the frequency domain to determine the diffuse spot radius.

In some embodiments, values may be assigned to u and v, and each new (u, v) may be determined by the assigned values. By solving Equation (2), a new Rᵢ(x, y) may be acquired. Further, the number of the specific assignments may be set as needed.

In some embodiments, determining the at least one diffuse spot radius may include determining the diffuse spot radius by solving a least square relationship between the coordinates of the pixel points in relation with of the frequency domain and the paired images.

In some embodiments, the least square relationship between 0.5N(N−1) image pairs (Iᵢ, Iⱼ) and W×W (x,y) corresponding to W×W (u, v) may be established, in which

$${{min}_{{R}_{i}^{2} ( x , y ) {R}_{j}^{2} ( x , y )} {\sum }_{i , j} {\sum }_{( u , v )} [ ln \frac{F ( {I}_{i}^{W} ) ( u , v )}{F ( {I}_{j}^{W} ) ( u , v )} - \sqrt{2 π} ( {R}_{j}^{2} ( x , y ) - {R}_{i}^{2} ( x , y ) ) ( {u}^{2} + {v}^{2} ) ) ]}^{2} .$$

This equation involves quadratic programming problems, which can be solved by using a mathematical tool library in related technologies. Subsequently, the diffuse spot radius of the pixel point in each image after squaring, that is, {Rᵢ(x, y)}₁^{N}. In other words, the R (x, y) of any image may be acquired.

In some embodiments, the pixel point used as the center may be predetermined or selected in real time.

In some embodiments, the pixel point used as the center, that is, the pixel point of the predetermined position, the predetermined position corresponding to the pixel point may be predetermined or selected by the user in real time. For example, the position may be predetermined as the center position of the image.

In some embodiments, respectively calculating the depth value of the pixel point in an image for an image whose serial number may be less than the first serial number and an image whose serial number may be greater than the first serial number based on the diffuse spot radius may include determining the depth value of the pixel point in the image based on the diffuse spot radius of the image, the aperture value of the image acquisition device, the focal length of the image acquisition device, and the object distance of the pixel point in the image.

In particular, when the adjustable distance is from the maximum imaging distance to the minimum imaging distance, respectively calculating the depth value of the pixel point in an image for an image whose serial numbers may be less than the first serial number and an image whose serial number may be greater than the first serial number based on the diffuse spot radius may include calculating the depth value of the pixel point (x, y) in the image for an image whose serial number i may be less than the first serial number based on the following equation:

$${D}_{i} ( x , y ) = \frac{{f}^{2} {d}_{o}^{i}}{- 2 {d}_{o}^{i} {R}_{i} ( x , y ) A + 2 {fR}_{i} ( x , y ) A + {f}^{2}} .$$

FIG. 6 is diagram of the depth value according to an embodiment of the present disclosure.

In some embodiments, as shown in FIG. 6, if the serial number of the image is less than the first serial number, the depth of the pixel point may be greater than dₒⁱ, as such , the equation provided above may be used to calculate the depth value.

In some embodiments, the depth value of the pixel point (x,y) in the image may be calculated for ab image whose serial number i may be greater than the first serial number based on the following equation:

$${D}_{i} ( x , y ) = \frac{{f}^{2} {d}_{o}^{i}}{2 {d}_{o}^{i} {R}_{i} ( x , y ) A - 2 {fR}_{i} ( x , y ) A + {f}^{2}} .$$

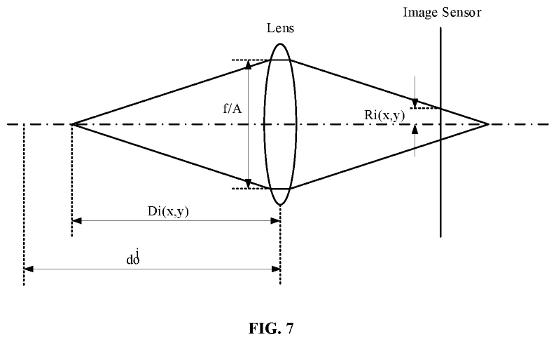

FIG. 7 is a diagram of another depth value according to an embodiment of the present disclosure.

In some embodiments, as shown in FIG. 7, if the serial number of the image is greater than the first serial number, the depth of the pixel point may be less than dₒⁱ, as such, the equation provided above may be used to calculate the depth value.

In particular, Dᵢ(x,y) may be depth value of the pixel point (x,y) in the i-th image Iᵢ in the N images, dₒⁱ may be the focusing distance in the i-th image Iᵢ in the N images, that is, the object distance, f may be the common focal length, A may be the aperture value, Rᵢ(x,y) may be the diffuse spot radius of the pixel point (x, y) in the ith image in the N images, where i may be an integer less than or equal to N.

In particular, when the adjustable distance is from the minimum imaging distance to the maximum imaging distance, respectively calculating the depth value of the pixel point in an image for an image whose serial number may be less than the first serial number and an image whose serial number may be greater than the first serial based on the diffuse spot radius may include calculating the depth value of the pixel point (x, y) in the image for images whose serial number i may be less than the first serial number based on the following equation:

$${D}_{i} ( x , y ) = \frac{{f}^{2} {d}_{o}^{i}}{- 2 {d}_{o}^{i} {R}_{i} ( x , y ) A + 2 {fR}_{i} ( x , y ) A + {f}^{2}} .$$

Further, the depth value of the pixel point (x, y) in the image may be calculated for an image whose serial number i is greater than the first serial number based on the following equation:

$${D}_{i} ( x , y ) = \frac{{f}^{2} {d}_{o}^{i}}{- 2 {d}_{o}^{i} {R}_{i} ( x , y ) A + 2 {fR}_{i} ( x , y ) A + {f}^{2}} ,$$

where Dᵢ(x, y) may be depth value of the pixel point (x, y) in the i-th image Iᵢ in the N images, dₒⁱ may be the focusing distance in the i-th image Iᵢ in the N images, that is, the object distance, f may be the common focal length, A may be the aperture value, Rᵢ(x, y) may be the diffuse spot radius of the pixel point (x, y) in the ith image in the N images, where i may be an integer less than or equal to N.

In some embodiments, calculating the depth value of the pixel point in the image based on the two methods described above may be distinguished into two use cases. In the first use case, the adjustable distance is from the maximum imaging distance to the minimum distance. In the second use case, the adjustable distance is from the minimum imaging distance to the maximum distance. In addition, the use cases may be further distinguished into an image whose serial number may be greater than the first serial number, and an image whose serial number may be less than the first serial number. As such, a comprehensive and accurate calculation of the depth value of the pixel point in the image may be ensured.

In some embodiments, linear processing may be performed on the image before calculating the diffuse spot radius of the pixel point in the image.

In some embodiments, the linear processing may include processing such as demosaicing, white balancing, etc., such that the linearly process image may retain the linear characteristics. The processed N images may be noted as {Iᵢ}ᵢ₌₁^{N}, the common focal length may be noted as f, the aperture may be noted as A, and the focusing distance may be noted as {dₒⁱ}ᵢ₌₁^{N}.

In some embodiments, based on the embodiment shown in FIG. 1, the method may further include determining a target image in the N images based on a received instruction or a predetermined rule; and performing sharpening processing and/or blur compensation and/or weakening processing on the target image.

In some embodiments, in the N images, an image may be selected by the user as the target image, or an image acquisition device may automatically determine an image as the target image form the N images based on a predetermined rule, the a sharpening processing may be performed on the image. As such, a part of the image may be clear. Further, a blur compensation and/or a weakening processing may be performed such that a part of the image may be blurred.

In some embodiments, determining the target image in the N images based on the received instruction may include determining an image corresponding to the depth value of the pixel point of a target position having the smallest difference in the depth value with a target depth value as the target image in the N images based on the input target position.

In some embodiments, the user may perform a click operation on a touch screen displaying the image, and the position corresponding to the click operation may be the target position. Further, the target depth value of the pixel point at the position may be determined based on the target depth value of the pixel point acquired through the embodiment shown in FIG. 1. Subsequently, the depth value of the pixel point at the position in each of the N images may be compared with the target depth value of the pixel point at the position, and the image corresponding to the depth value with the smallest difference may be determined as the target image.

In some embodiments, performing the sharpening processing on the target image may include calculating the foreground depth of field and the background depth of field for the target image; determining a first type of pixel points in the target image whose target depth value may be between the foreground depth of field and the background depth of field; and performing sharpening processing on the first type of pixel points.

In some embodiments, for the first type of pixel points in the target image whose target depth value may be between the foreground depth of field and the background depth of field, the user can clearly see the patterns made up this type of pixel points with dots, as such these pixel points may be sharpened to make them more clear, thereby highlighting the differences between the first type of pixel points and other pixel points.

In some embodiments, calculating the foreground depth of field and the background depth of field may include calculating the foreground depth of field based on the following equation:

$${d}_{o , f} = \frac{{f}^{2} {d}_{o , j}}{2 {d}_{o , j} {R}_{l} A - 2 {fR}_{l} A + {f}^{2}} ,$$

and calculating the background depth of field based on the following equation:

$${d}_{o , b} = \frac{{f}^{2} {d}_{o , j}}{- 2 {d}_{o , j} {R}_{l} A + 2 {fR}_{l} A + {f}^{2}} ,$$

where d_{o,j} may be the focusing distance of the pixel point (x, y) in the predetermined image in the N images, that is, the object distance, f may be the common focal length, A may be the aperture value, and Rₗ may be the predetermined extreme diffuse spot radius.

In some embodiments, performing sharpening processing on the first type of pixel points may include sharpening the first type of pixel points by using frequency domain inverse filtering.

In some embodiments, before determining the first type of pixel points further include determining an optimal pixel point where the difference between the depth value and the object distance in the image is less than a predetermined value and determining a partial image in the image by using the optimal pixel point as the center; and synthesizing the partial image in each of the N images into a focused image through a weighted mask.

In particular, determining the first type of pixel points in the image that may be located between the foreground depth of field and the background depth of field based on the depth value may include determining the first type of pixel points in the focused image that may be located between the foreground depth of field and the background depth of field based on the depth value.

In some embodiments, a pixel point with the relatively small (less than the predetermined value) difference may be determined based on the difference between the depth value and the object distance, then the partial image may be determined by using the pixel point as the center. Subsequently, the partial images in the N images may be synthesized to acquire a synthesized image with a high degree of focus, which may be convenient for further sharpening the synthesized image.

In some embodiments, performing blur compensation and/or weakening processing on the target image may include calculating the foreground depth of field and the background depth of filed for the target image; determining a second type of pixel points in the target image whose target depth value may not be between the foreground depth of field and the background depth of field; and performing blur compensation and/or weakening processing on the second type of pixel points.

In some embodiments, for the second type of pixel points in the target image whose target depth value may not be between the foreground depth of field and the background depth of field, the user cannot clearly see the patterns made up this type of pixel points with dots, as such blur compensation and/or weakening processing may be performed on these pixel points to further blur them, thereby highlighting the differences between the second type of pixel points and other pixel points.

In some embodiments, performing blur compensation and/or weakening processing on the second type of pixel points may include calculating a true diffuse spot radius R(x, y) and a virtual diffuse spot radius R′(x,y), in which

$$R ( x , y ) = \frac{{f}^{2} ( {d}_{o , j} - D ( x , y ) )}{2 AD ( x , y ) ( {d}_{o , j} - f )} , where$$

$$D ( x , y ) < {d}_{o , j} ; R ( x , y ) = \frac{{f}^{2} ( D ( x , y ) - {d}_{o , j} )}{2 A {d}_{o , j} ( D ( x , y ) - f )} , where$$

$$D ( x , y ) > {d}_{o , j} ; {R}^{′} ( x , y ) = \frac{{f}^{2} ( {d}_{o , j} - D ( x , y ) )}{2 {A}^{′} D ( x , y ) ( {d}_{o , j} - f )} , where$$

$$D ( x , y ) < {d}_{o , j} ; and {R}^{′} ( x , y ) = \frac{{f}^{2} ( D ( x , y ) - {d}_{o , j} )}{2 {A}^{′} {d}_{o , j} ( D ( x , y ) - f )} ,$$

where D(x, y)>d_{o,j}. In particular, d_{o,j} may be the focusing distance of the pixel point (x,y) in the predetermined image in the N image, that is, the object distance, f may be the common focal length, A may be the aperture value, A′ may be the virtual aperture value, and Rₗ may be the predetermined extreme diffuse spot radius.

A true fuzzy function may be determined based on a relationship between the true diffuse spot radius and the fuzzy function of any of the N images. Further, a virtual fuzzy function may be determined based on a relationship between the virtual diffuse spot radius and the fuzzy function of any one of the N images.

In some embodiments, the true fuzzy function h(x, y) may be acquired by bringing the true diffuse spot radius R(x, y) into Equation (3):

$${h}_{i} ( x , y ) = \frac{1}{\sqrt{2 π {R}_{i}^{2} ( x , y )}} exp ( - \frac{{x}^{2} + {y}^{2}}{2 {R}_{i}^{2} ( x , y )} ) ,$$

where h,(x, y) may be the fuzzy function of the i-th image Iᵢ in the N images, i may be less than or equal to N, and i may be an integer.

In some embodiments, the virtual fuzzy function h′(x,y) may be acquired by bringing the virtual diffuse spot radius R′(x, y) into Equation (3). Subsequently, the value of the inverse Fourier transform of the ratio of the Fourier transform of the virtual fuzzy function and the Fourier transform of the truefuzzy function of the second type of pixel points, and the value of a variable convolution operation of the target image may be calculated.

In some embodiments,

$${h}^{″} ( x , y ) = {F}^{- 1} ( \frac{F ( {h}^{′} ( x , y ) )}{F ( h ( x , y ) )} )$$

may be calculated, where F( ) may be the Fourier transform, and F⁻¹ may be the inverse Fourier transform. Subsequently, I(x,y)=Iⱼ [symbol] h″(x,y) may be calculated, where [symbol] may be the spatially variable convolution operation, thereby realizing the blur compensation and/or weakening processing of the pixel points.

In some embodiments, before determining the second type of pixel points further include determining an optimal pixel point where the difference between the depth value and the object distance in the image is less than a predetermined value and determining a partial image in the image by using the optimal pixel point as the center; and synthesizing the partial image in each of the N images into a focused image through a weighted mask.

In particular, determining the second type of pixel points in the image that may not be located between the foreground depth of field and the background depth of field based on the depth value may include determining the second type of pixel points in the focused image that may not be located between the foreground depth of field and the background depth of field based on the depth value.

In some embodiments, a pixel point with the relatively small (less than the predetermined value) difference may be determined based on the difference between the depth value and the object distance, then the partial image may be determined by using the pixel point as the center. Subsequently, the partial images in the N images may be synthesized to acquire a synthesized image with a high degree of focus, which may be convenient for further performing blur compensation and/or weakening processing on the synthesized image.

In some embodiments, if N>2, the imaging distance corresponding to the first image in the N images may be less than or equal to the focal length, and the imaging distance corresponding to the Nth image may be greater than or equal to twice the focal length.

In some embodiments, if N=2, the imaging distance corresponding to the first image in the N images may be equal to the focal length, and the imaging distance corresponding to the second image may be equal to twice the focal length.

By using the embodiments of the present disclosure, the imaging distance of the acquired image may be ensured to cover at least the focal length and twice the focal length, thereby ensuring the accuracy of the subsequent calculation of the target depth value. In the case of N=2, the number of acquired images can be greatly reduced, thereby reducing the complexity of calculating the target depth value.

In some embodiments, before adjusting the adjustable distance may further include setting the focal length of the image acquisition device.

In some embodiments, the focal length of the image acquisition device can be set in advance such that the process described in the embodiment shown in FIG. 1 may be performed when the focal length is determined, thereby ensuring the focal length of each acquired image may be unchanged and further ensuring the accuracy of the subsequent calculation of the target depth value.

In some embodiments, the image sensor may be moved by using a piezoelectric motor.

In some embodiments, the piezoelectric motor may be driven based on the piezoelectric inverse effect, which may have a relatively small impact on external electromagnetic interference and noise, a relatively small volume, and a relatively low manufacturing cost, which may reduce the product cost and improve the battery life.

It should be noted that the embodiments described above can be applied to the case of focusing first and acquiring image later, or the case of acquiring image first and focusing later. In the case of acquiring image first and focusing later, for all the pixel points in the acquired image, the depth value can be determined based on the embodiments described above, and the focal length may be set for the image after the depth value of the pixel point is determined for focusing.

An embodiment of the present disclosure further provides an apparatus for determining a depth value, which may be applicable to an image acquisition device. The image acquisition device includes a lens and an image sensor. The apparatus for determining the depth value includes a processor, and the processor may be configured to adjust an adjustable distance between the image sensor and the lens M times by moving the image sensor, where M may be an integer greater than 1; acquire an image for each N of M times after adjusting the adjustable distance, where N may be an integer less than or equal to M; calculate depth values of pixel points in the N acquired images; and determine a target depth value of the pixel point at a predetermined position in the image based on the depth value of the pixel point in each image.

In some embodiments, the processor may be further configured to adjust the adjustable distance M time based on the same or different step values.

In some embodiments, the processor may be further configured to calculate the diffuse spot radius of the pixel point at the predetermined position in the image; set serial numbers for the N images based on the acquisition order of the N images; determining the minimum diffuse spot radius among the diffuse spot radii and a first serial number of a corresponding image among the N images; and calculate the depth values of the pixel points in the image respectively for the image whose serial number may be less than the first serial number and the image whose serial number may be greater than the first serial number based on the diffuse point radius.

In some embodiments, the processor may be further configured to pair the N images in pairs; acquire a first partial image in a first image of the paired images with the pixel point of the predetermined position as the center and acquire a second partial image in a second image of the paired images; and determine one or more diffuse spot radii based on a relationship between a ratio of a Fourier transform of the first partial image and a Fourier transform of the second partial image, and a ratio of a Fourier transform of a fuzzy function of a pixel point in the first image and a Fourier transform of a fuzzy function of a pixel point in the second image.

In some embodiments, the processor may be further configured to assign values to the coordinates of the pixel points in relation with of the frequency domain to determine the diffuse spot radius.

In some embodiments, the processor may be further configured to determine the diffuse spot radius by solving a least square relationship between the coordinates of the pixel points in relation with of the frequency domain and the paired images.

In some embodiments, the pixel point used as the center may be predetermined or selected in real time.

In some embodiments, when the adjustable distance is from the maximum imaging distance to the minimum imaging distance, the processor may be further configured to determine the depth value of the pixel point in the image based on the diffuse spot radius of the image, the aperture value of the image acquisition device, the focal length of the image acquisition device, and the object distance of the pixel point in the image.

In some embodiments, the processor may be further configured to perform linear processing on the image before calculating the diffuse spot radius of the pixel point in the image.

In some embodiments, the processor may be further configured to determine a target image in the N images based on a received instruction or a predetermined rule; and perform sharpening processing and/or blur compensation and/or weakening processing on the target image.

In some embodiments, the processor may be further configured to determine an image corresponding to the depth value of the pixel point of a target position having the smallest difference in the depth value with a target depth value as the target image in the N images based on the input target position.

In some embodiments, the processor may be further configured to calculate the foreground depth of field and the background depth of field for the target image; determine a first type of pixel points in the target image whose target depth value may be between the foreground depth of field and the background depth of field; and perform sharpening processing on the first type of pixel points.

In some embodiments, the processor may be further configured to sharpen the first type of pixel points by using frequency domain inverse filtering.

In some embodiments, before determining the first type of pixel points, the processor may be further configured to determine an optimal pixel point where the difference between the depth value and the object distance in the image is less than a predetermined value and determine a partial image in the image by using the optimal pixel point as the center; synthesize the partial image in each of the N images into a focused image through a weighted mask; and determine the first type of pixel points in the focused image that may be located between the foreground depth of field and the background depth of field based on the depth value.

In some embodiments, the processor may be further configured to calculate the foreground depth of field and the background depth of filed for the target image; determine a second type of pixel points in the target image whose target depth value may not be between the foreground depth of field and the background depth of field; and perform blur compensation and/or weakening processing on the second type of pixel points

In some embodiments, the processor may be further configured to calculate a true diffuse spot radius and a virtual diffuse spot radius for the second type of pixel points; determine a true fuzzy function based on a relationship between the true diffuse spot radius and the fuzzy function of any of the N images; determine a virtual fuzzy function based on a relationship between the virtual diffuse spot radius and the fuzzy function of any one of the N images; and calculate the value of the inverse Fourier transform of the ratio of the Fourier transform of the virtual fuzzy function and the Fourier transform of the true fuzzy function of the second type of pixel points, and the value of a variable convolution operation of the target image.

In some embodiments, before determining the second type of pixel points, the processor may be further configured to determine an optimal pixel point where the difference between the depth value and the object distance in the image is less than a predetermined value and determine a partial image in the image by using the optimal pixel point as the center; and synthesize the partial image in each of the N images into a focused image through a weighted mask.

In particular, determining the second type of pixel points in the image that may not be located between the foreground depth of field and the background depth of field based on the depth value may include determining the second type of pixel points in the focused image that may not be located between the foreground depth of field and the background depth of field based on the depth value.

In some embodiments, if N>2, the imaging distance corresponding to the first image in the N images may be less than or equal to the focal length, and the imaging distance corresponding to the Nth image may be greater than or equal to twice the focal length.

In some embodiments, if N=2, the imaging distance corresponding to the first image in the N images may be equal to the focal length, and the imaging distance corresponding to the second image may be equal to twice the focal length.

In some embodiments, before adjusting the adjustable distance, the processor may be further configured set the focal length of the image acquisition device.

In some embodiments, the processor may be further configured to move the image senor by using a piezoelectric motor.

An embodiment of the present disclosure further provides a machine-readable storage medium which may be applicable to an image acquisition device. The image acquisition device includes a lens and an image sensor. A plurality of computer instructions may be stored on the machine-readable storage medium, and the computer instructions may be executed to implement the steps described in any one of the foregoing method embodiments.

In some embodiments, the computer instructions may be executed to adjust an adjustable distance between the image sensor and the lens M times by moving the image sensor, where M may be an integer greater than 1; acquire an image for each N of M times after adjusting the adjustable distance, where N may be an integer less than or equal to M; calculate depth values of pixel points in the N acquired images; and determine a target depth value of the pixel point at a predetermined position in the image based on the depth value of the pixel point in each image.

In some embodiments, the computer instructions may be executed to adjust the adjustable distance M time based on the same or different step values.

In some embodiments, the computer instructions may be executed to calculate the diffuse spot radius of the pixel point at the predetermined position in the image; set serial numbers for the N images based on the acquisition order of the N images; determine the minimum diffuse spot radius among the diffuse spot radii and a first serial number of a corresponding image among the N images; and calculate the depth values of the pixel points in the image respectively for the image whose serial number may be less than the first serial number and the image whose serial number may be greater than the first serial number based on the diffuse point radius.

In some embodiments, the computer instructions may be executed to pair the N images in pairs; acquire a first partial image in a first image of the paired images with the pixel point of the predetermined position as the center and acquire a second partial image in a second image of the paired images; and determine one or more diffuse spot radii based on a relationship between a ratio of a Fourier transform of the first partial image and a Fourier transform of the second partial image, and a ratio of a Fourier transform of a fuzzy function of a pixel point in the first image and a Fourier transform of a fuzzy function of a pixel point in the second image.

In some embodiments, the computer instructions may be executed to assign values to the coordinates of the pixel points in relation with of the frequency domain to determine the diffuse spot radius.

In some embodiments, the computer instructions may be executed to determine the diffuse spot radius by solving a least square relationship between the coordinates of the pixel points in relation with of the frequency domain and the paired images.

In some embodiments, the pixel point used as the center may be predetermined or selected in real time.

In some embodiments, when the adjustable distance is from the maximum imaging distance to the minimum imaging distance, the computer instructions may be executed to determine the depth value of the pixel point in the image based on the diffuse spot radius of the image, the aperture value of the image acquisition device, the focal length of the image acquisition device, and the object distance of the pixel point in the image.

In some embodiments, the computer instructions may be executed to perform linear processing on the image before calculating the diffuse spot radius of the pixel point in the image.

In some embodiments, the computer instructions may be executed to determine a target image in the N images based on a received instruction or a predetermined rule; and perform sharpening processing and/or blur compensation and/or weakening processing on the target image.

In some embodiments, the computer instructions may be executed to determine an image corresponding to the depth value of the pixel point of a target position having the smallest difference in the depth value with a target depth value as the target image in the N images based on the input target position.

In some embodiments, the computer instructions may be executed to calculate the foreground depth of field and the background depth of field for the target image; determine a first type of pixel points in the target image whose target depth value may be between the foreground depth of field and the background depth of field; and perform sharpening processing on the first type of pixel points.

In some embodiments, the computer instructions may be executed to sharpen the first type of pixel points by using frequency domain inverse filtering.

In some embodiments, before determining the first type of pixel points, the computer instructions may be executed to determine an optimal pixel point where the difference between the depth value and the object distance in the image is less than a predetermined value and determine a partial image in the image by using the optimal pixel point as the center; synthesize the partial image in each of the N images into a focused image through a weighted mask; and determine the first type of pixel points in the focused image that may be located between the foreground depth of field and the background depth of field based on the depth value.

In some embodiments, the computer instructions may be executed to calculate the foreground depth of field and the background depth of filed for the target image; determine a second type of pixel points in the target image whose target depth value may not be between the foreground depth of field and the background depth of field; and perform blur compensation and/or weakening processing on the second type of pixel points.

In some embodiments, the computer instructions may be executed to calculate a true diffuse spot radius and a virtual diffuse spot radius for the second type of pixel points; determine a true fuzzy function based on a relationship between the true diffuse spot radius and the fuzzy function of any of the N images; determine a virtual fuzzy function based on a relationship between the virtual diffuse spot radius and the fuzzy function of any one of the N images; and calculate the value of the inverse Fourier transform of the ratio of the Fourier transform of the virtual fuzzy function and the Fourier transform of the true fuzzy function of the second type of pixel points, and the value of a variable convolution operation of the target image.

In some embodiments, before determining the second type of pixel points, the computer instructions may be executed to determine an optimal pixel point where the difference between the depth value and the object distance in the image is less than a predetermined value and determine a partial image in the image by using the optimal pixel point as the center; and synthesize the partial image in each of the N images into a focused image through a weighted mask.

In particular, determining the second type of pixel points in the image that may not be located between the foreground depth of field and the background depth of field based on the depth value may include determining the second type of pixel points in the focused image that may not be located between the foreground depth of field and the background depth of field based on the depth value.

In some embodiments, if N>2, the imaging distance corresponding to the first image in the N images may be less than or equal to the focal length, and the imaging distance corresponding to the Nth image may be greater than or equal to twice the focal length.

In some embodiments, if N=2, the imaging distance corresponding to the first image in the N images may be equal to the focal length, and the imaging distance corresponding to the second image may be equal to twice the focal length.

In some embodiments, before adjusting the adjustable distance, the computer instructions may be executed set the focal length of the image acquisition device.

In some embodiments, the computer instructions may be executed to move the image senor by using a piezoelectric motor.

An embodiment of the present disclosure further provides a mobile device including a lens, an image sensor, and one or more processors working separately or in conjunction. The one or more processors may be configured to adjust an adjustable distance between the image sensor and the lens M times by moving the image sensor, where M may be an integer greater than 1; acquire an image for each N of M times after adjusting the adjustable distance, where N may be an integer less than or equal to M; calculate depth values of pixel points in the N acquired images; and determine a target depth value of the pixel point at a predetermined position in the image based on the depth value of the pixel point in each image.

In various embodiments, the system, apparatus, module, or unit may be implemented by a computer chip or hardware or may be implemented by a product having a certain function. For the convenience of description, the apparatus may be divided into units according to functions and each of the units may be described separately. The unit functions may be implemented in one or more software and/or hardware modules. Those having ordinary skill in the art should understand that the embodiments of the present disclosure may be provided as methods, systems, or computer program products. Thus, the present disclosure may be implemented entirely in hardware, entirely in software, or in combination of hardware and software. Moreover, the present disclosure may be implemented by one or more computer program products in the form of computer readable storage media (including, but not limited to, magnetic disk memory, CD-ROM, optical disk memory, etc.) containing computer executable program codes.

The embodiments of the present disclosure are described in a progressive manner. The same or similar portion among the embodiments can be referred to each other. Each embodiment will be described with the focus on the differences as compared to other embodiments. Due to similarity to the method embodiments, the system embodiments are briefly described. For the related portions, reference may be made to the corresponding description of the method embodiments.

It should be noted that in the present disclosure, relational terms such as first and second, etc., are only used to distinguish an entity or operation from another entity or operation, and do not necessarily imply that there is an actual relationship or order between the entities or operations. The terms “comprising,” “including,” or any other variations are intended to encompass non-exclusive inclusion, such that a process, a method, an apparatus, or a device having a plurality of listed items not only includes these items, but also includes other items that are not listed, or includes items inherent in the process, method, apparatus, or device. Without further limitations, an item modified by a term “comprising a . . . ” does not exclude inclusion of another same item in the process, method, apparatus, or device that includes the item

Described above are merely embodiments of the present disclosure, and are not intended to limit the scope of the present disclosure. Those having ordinary skill in the art may appreciate various modifications and changes. Any modifications, equivalent substitutions, and improvements made within the spirit and principle of the present disclosure should be included in the scope of the present disclosure.

What is claimed is:

1. A method for determining a depth value, comprising:
adjusting a distance between an image sensor and a lens included in an image acquisition device M times by moving the image sensor, where M is an integer greater than 1;
acquiring an image for each N of M times after adjusting the distance between the image sensor and the lens, where N is an integer less than or equal to M;
calculating depth values of pixel points in the N acquired images; and
determining a target depth value of the pixel point at a position in each of the images based on the depth value of the pixel point in each image.

2. The method of claim 1, wherein adjusting the distance between the image sensor and the lens M times includes:
adjusting the distance between the image sensor and the lens M times based on a same or based on different step values.

3. The method of claim 1, wherein calculating the depth values of the pixel points in the N acquired images includes:
calculating a diffuse spot radius of the pixel point at the position in each image;
setting serial numbers for the N images based on the acquisition order of the N images;
determining a minimum diffuse spot radius in the diffuse spot radii and a first serial number of an image corresponding to the minimum diffuse spot radius in the N images; and
calculating the depth values of the pixel points for an image whose serial number is less than the first serial number and for an image whose serial number is greater than the first serial number based on the diffuse point radius.

4. The method of claim 3, wherein calculating the diffuse spot radius of the pixel point at the position in the image includes:
pairing the N images in pairs;
acquiring a first partial image in a first image of the paired images with the pixel point of the position as a center and acquiring a second partial image in a second image of the paired images; and
determining one or more diffuse spot radii based on a relationship between a ratio of a Fourier transform of the first partial image and a Fourier transform of the second partial image, and a ratio of a Fourier transform of a fuzzy function of the pixel point in the first image and a Fourier transform of a fuzzy function of the pixel point in the second image.

5. The method of claim 4, wherein determining one or more diffuse spot radius includes:
assigning values to coordinates of the pixel points in relation with of a frequency domain to determine the diffuse spot radius.

6. The method of claim 4, wherein determining one or more diffuse spot radius includes:
determining the diffuse spot radius by solving a least square relationship between the coordinates of the pixel points in relation with of the frequency domain and the paired images.

7. The method of claim 4, wherein the pixel point used as the center is predetermined or selected in real time.

8. The method of claim 3, wherein calculating the depth values of the pixel points for the image whose serial number is less than the first serial number and the image whose serial number is greater than the first serial number based on the diffuse point radius includes:
determining the depth value of the pixel point for the image whose serial number is less than the first serial number and the image whose serial number is greater than the first serial number based on the diffuse spot radius of the image, the aperture value of the image acquisition device, the focal length of the image acquisition device, and the object distance of the pixel point in the image.

9. The method of claim 3, before calculating the diffuse spot radius of the pixel point at the position in each image further includes:
performing linear processing on the image.

10. The method of claim 1, further comprising:
determining a target image in the N images based on a received instruction or a rule; and
performing sharpening processing, blur compensation, or weakening processing on the target image.

11. The method of claim 10, wherein determining the target image in the N images based on the received instruction includes:
determining an image corresponding to the depth value of the pixel point of a target position having a smallest difference in the depth value with a target depth value as the target image in the N images based on the input target position.

12. The method of claim 10, wherein performing sharpening processing on the target image includes:
calculating a foreground depth of field and a background depth of field for the target image;
determining a first type of pixel points in the target image whose target depth value is between the foreground depth of field and the background depth of field; and
performing sharpening processing on the first type of pixel points.

13. The method of claim 12, wherein performing sharpening processing on the first type of pixel points includes:
sharpening the first type of pixel points by using frequency domain inverse filtering.

14. The method of claim 12, wherein before determining the first type of pixel points further includes:
determining an optimal pixel point where a difference between the depth value and an object distance in the image is less than a value and determining a partial image in the image by using the optimal pixel point as the center; and
synthesizing the partial image in each of the N images into a focused image through a weighted mask, and
wherein determining the first type of pixel points in the target image whose target depth value is between the foreground depth of field and the background depth of field includes:
determining the first type of pixel points in the focused image being located between the foreground depth of field and the background depth of field based on the depth value.

15. The method of claim 10, performing blur compensation or weakening processing to the target image includes:
calculating a foreground depth of field and a background depth of filed for the target image;
determining a second type of pixel points in the target image whose target depth value is not located between the foreground depth of field and the background depth of field; and
performing blur compensation or weakening processing on the second type of pixel points.

16. The method of claim 15, wherein performing blur compensation or weakening processing on the second type of pixel points includes:
calculating a true diffuse spot radius and a virtual diffuse spot radius for the second type of pixel points;
determining a true fuzzy function based on a relationship between the true diffuse spot radius and the fuzzy function of any of the N images;
determining a virtual fuzzy function based on a relationship between the virtual diffuse spot radius and the fuzzy function of any of the N images; and
calculating a value of an inverse Fourier transform of the ratio of the Fourier transform of the virtual fuzzy function and the Fourier transform of the true fuzzy function of the second type of pixel points, and a value of a variable convolution operation of the target image.

17. The method of claim 15, before determining the second type of pixel points further includes:
determining an optimal pixel point where the difference between the depth value and an object distance in the image is less than a value and determining a partial image in the image by using the optimal pixel point as the center; and
synthesizing the partial image in each of the N images into a focused image through the weighted mask, and
wherein determining the second type of pixel points in the target image whose target depth value is not located between the foreground depth of field and the background depth of field includes:
determining the second type of pixel points in the focused image not being located between the foreground depth of field and the background depth of field based on the depth value.

18. The method of claim 1, wherein:
if N>2, an imaging distance corresponding to a first image in the N images is less than or equal to a focal length, and the imaging distance corresponding to the Nth image is greater than or equal to twice the focal length, and
if N=2, the imaging distance corresponding to the first image in the N images equals to the focal length, and the imaging distance corresponding to a second image equals to twice the focal length.

19. An apparatus for determining a depth value comprising:
a processor configured to:
adjust a distance between an image sensor and a lens included in an image acquisition device M times by moving the image sensor, where M is an integer greater than 1;
acquire an image for each N of M times after adjusting the distance between the image sensor and the lens, where N is an integer less than or equal to M;
calculate depth values of pixel points in the N acquired images; and
determine a target depth value of the pixel point at a position in the image based on the depth value of the pixel point in each image.

20. A mobile device comprising:
a lens;
an image sensor; and
one or more processors working separately or in conjunction configured to:
adjust a distance between the image sensor and the lens M times by moving the image sensor, where M is an integer greater than 1;
acquire an image for each N of M times after adjusting the distance between the image sensor and the lens, where N is an integer less than or equal to M;
calculate depth values of pixel points in the N acquired images; and
determine a target depth value of the pixel point at a position in the image based on the depth value of the pixel point in each image.
